(19) United States
(12) Patent Application Publication
(10) Pub. No.: US 2019/0255695 A1
(43) Pub. Date: Aug. 22, 2019

(54) Adjustable Tool Bucket Systems

(71) Applicant: Ty-Flot, Inc., Manchester, NH (US)

(72) Inventors: Darrell A. Moreau, Manchester, NH (US); Andre W. Moreau, Bedford, NH (US)

(21) Appl. No.: 15/899,262

(22) Filed: Feb. 19, 2018

(51) Int. Cl. B25H 3/00; B65D 1/12; B65D 25/28

(52) U.S. Cl. CPC B25H 3/00; B65D 25/2876; B65D 1/12

(57) ABSTRACT

An adjustable tool bucket having at least one of an adjustable hanging suspension system; an adjustable belt system; and an adjustable sidewall support system. The adjustable hanging suspension system, capable of extending a handle portion of the adjustable tool bucket enabling shifting between multiple suspension positions. The adjustable sidewall support system has first and second sidewall support brackets. The adjustable tool belt support system capable of extending a volume of the internal space of the adjustable tool bucket.

### BACKGROUND OF THE INVENTION

### 1. Field of the Invention

The present invention relates generally to buckets for storing and transporting hand tools. Particularly, the present invention relates to an adjustable portable tool storage bucket having adjustable component systems for adjusting a volume of the bucket's internal storage capacity, a total carrying capacity of the bucket, and a length of the bucket carrying strap.

### 2. Description of the Prior Art

Persons engaged in repair, construction, and industrial maintenance use a variety of hand tools to perform their work. The worker may use a tool belt, but often also carries a tool box or tool bag to carry tools that cannot be stored on the tool belt due to space or size limitations.

One form of a tool bag is a tool bucket made of canvas or other pliable material and including a flexible handle with a connector hook. For example, one hanging tool bucket has a generally cylindrical container made of heavy canvas. The sidewall of the container tapers slightly from the mouth towards the bottom of the bucket. A rope handle is secured to opposite sides of the bucket along the mouth. Optionally, the user may attach a swivel snap hook to the handle for hanging the tool bucket. The user clips the snap hook to a ladder hook, ceiling hook, or overhead cable to suspend the tool bag off of the ground for convenient access to tools.

### SUMMARY OF THE INVENTION

A deficiency of conventional tool bags is that the carrying strap is designed for carrying the tool bucket rather than to be used for hanging the bucket. A hook or connector attached to the carrying strap or handle is typically not large enough to clip onto beams, large pipes, and other structural members. A connector large enough to attach to these structures would be unwieldy and heavy. Thus, the tool bag or tool bucket can only be suspended off the ground when an appropriately sized hook is available.

One approach to this problem has been to supply a separate tie-down strap or bungee cord that loops over a pipe or other structure and then hooks to the handle or connector on the tool bag. A deficiency with this approach is that the user must remember to pack the tie-down strap in the tool bag for it to be useful when needed. The tie-down strap consumes space in the tool bag and sometimes can get moved to the bottom of the bag underneath tools where it is a hassle to retrieve.

Another deficiency when using a separate tie-down strap is that when a worker hoists a loaded tool bag up to the height of the tie-down strap, brings the ends of the tie-down strap together, and then clips a connector to the tie-down strap, these actions may result in tipping the tool bag, bumping the tool bag, or a missed attempt to clip the connector on the strap or handle that causes dropping tools or other equipment. When working at height or in a location with equipment or people located below, a dropped strap with metal connector or a dropped tool can damage equipment and cause serious injury to workers below.

Therefore, what is needed is a tool storage bucket, such as a tool bag, that has a carrying handle equipped for connection to structures that are too large for a common carabiner or hook. This eliminates the need for a separate tie-down strap and maintains the utility of the carrying handle for carrying the tool bag. The present invention achieves these and other objectives by providing a tool-bucket carrying handle with an auxiliary loop.

One aspect of the present invention is directed to a tool bag with a container and a carrying handle with adjustable hanging suspension system. The container has a bottom and a sidewall extending up from the bottom to an open mouth. The carrying handle is made of a pliable material and has a body portion, a first end portion, and a second end portion, where the first end portion is attached to a first side of the container adjacent the open mouth and the second end portion is attached to a second side of the container adjacent the open mouth. The body portion of the carrying handle extends over the open mouth of the bucket. The adjustable hanging suspension system has an auxiliary member body secured at a first auxiliary end portion to the body portion of the carrying handle. The adjustable hanging suspension system extends along the auxiliary member body separate from and generally aligned with the carrying handle to a second auxiliary end portion that defines a closed loop. A bag-suspending connector is connected to the carrying handle. In one embodiment, the carrying handle and adjustable hanging suspension system are a strap, rope, or other pliable material. In one embodiment, for example, the carrying handle and adjustable hanging suspension system are made of nylon webbing, leather, or rope.

In some embodiments, the tool bag includes a releasable connector with a first connector part on the auxiliary member body portion and a second connector part on the body portion of the carrying handle, thereby rendering the adjustable hanging suspension system releasably attachable to the carrying handle. In one embodiment, the first auxiliary end portion of the adjustable hanging suspension system is secured at about the midpoint of the carrying handle and the auxiliary member body has a length sufficient to extend along the sidewall when the adjustable hanging suspension system is releasably attached to the body portion of the carrying handle. In another embodiment, the sidewall of the bucket also includes the second connector part, thereby also rendering the adjustable hanging suspension system releasably attachable to the sidewall of the bucket. In one embodiment, the releasable fastener is a hook-and-loop fastener.

In one embodiment, the handle body portion includes a first handle body portion and a second handle body portion, each of which includes a bag-suspending connector.

In various embodiments, the bag-suspending connector(s) may be slidable along the carrying handle or fixed at a predetermined location along the handle body portion, such at about the midpoint of the handle body.

In another embodiment, the first auxiliary end portion is secured to the carrying strap at about the midpoint of the body portion of the carrying handle that extends over the open mouth. For example, in one embodiment, the first end portion and the second end portion of the carrying strap are permanently secured to the bucket. In another embodiment, one or both of the first end portion and the second end portion of the carrying strap includes a connector that is releasably connected through an opening in the sidewall adjacent the mouth of the bucket. Thus, in some embodiment, the carrying handle is removable from the bucket at one or both end portions.

In some embodiments, the bag-suspending connector is a carabiner or snap hook with a spring-loaded gate operable between an open position and a closed position. For example, the bag-suspending connector is a carabiner with a connector loop, where the carrying handle extends through the connector loop to connect the bag-suspending connector to the carrying handle. In other embodiments, the bag-suspending connector is a D-ring or other closed loop connector.

Another aspect of the present invention is directed to a tool bag carrying handle that includes a handle portion made of a pliable material and having a handle body extending between a first end portion and a second end portion. An adjustable hanging suspension system has a first auxiliary end portion secured to the handle portion and an auxiliary member body portion capable of extending in alignment with and along the handle portion to a second auxiliary end portion that defines a closed loop. A first-end connector is secured to the first end portion of the handle portion and operable between an open position and a closed position. A second-end connector is secured to the second end portion of the handle portion and operable between an open position and a closed position. A bag-suspending connector is connected to the handle portion.

In another embodiment, the carrying handle includes a releasable fastener having a first fastener part and a second fastener part. The first fastener part is attached to the adjustable hanging suspension system and the second fastener part is attached to the handle portion. When the auxiliary member body portion is brought together with the handle portion, the first fastener part is aligned to releasably engage the second fastener part. In one embodiment, the releasable fastener is a hook-and-loop fastener with the first fastener part being a loop portion and the second fastener part being a hook portion or vice versa.

In some embodiments, the bag-suspending connector is slidable along the handle portion. In other embodiments, the bag-suspending connector is fixed at about at a midpoint of the handle portion.

In some embodiments, the first auxiliary end portion defines a connector loop that is slidable along the handle portion. In other embodiments, the first auxiliary end portion has a fixed position along the handle portion, such as being fixed at or near a midpoint of the handle portion.

### BRIEF DESCRIPTION OF THE DRAWINGS

FIG. 1 is a perspective view of one embodiment of a flexible tool bucket with a suspension system having adjustable hanging suspension systems, belt support system, and carrying handle of the present invention.

FIG. 2 is a perspective view of another embodiment of a tool bucket with adjustable suspension system illustrating a first suspension position of the tool bucket of the present invention when supported or installed over a structure with the adjustable hanging suspension system captured by the bag-suspending connector, and the remaining portion of the adjustable hanging suspension system neatly folded back upon itself to prevent tangling.

FIG. 3 is a perspective view of another embodiment of a tool bucket with carrying handle and adjustable suspension system of the present invention showing the adjustable hanging suspension system extending down along the sidewall of the bucket.

FIG. 4 is a perspective view of one embodiment of a flexible tool bucket with a suspension system having adjustable hanging suspension systems, belt support system, and carrying handle of the present invention with connector along the final auxiliary loop.

FIG. 5 is a perspective view of one embodiment of a flexible tool bucket with an adjustable side wall support system having adjustable hanging suspension systems, and an openable mouth extending from the upper sidewall portion of the bucket.

FIG. 6 is a perspective view of one embodiment of a flexible tool bucket with an adjustable side wall support system having adjustable hanging suspension systems, an openable mouth extending along an uppermost portion of the upper sidewall portion of the bucket, a tool holster supported on an adjustable belt support system.

FIG. 7a-7d are perspective views of one embodiment of a rigid tool bucket with an adjustable inner sleeve; an adjustable side wall support system having adjustable hanging suspension systems; adjustable belt support system; and a locking belt supported by the adjustable belt support system.

FIG. 8-8b are perspective views of a flexible tool bucket with a suspension system, sidewall support system, carrying bracket, belt support system, and carrying handle of the present invention.

FIG. 9-9c are perspective view of other embodiments of a tool bucket with adjustable sidewall support system; adjustable suspension system illustrating a first suspension position of the tool bucket of the present invention when supported or installed over a structure with the adjustable hanging suspension system captured by the bag-suspending connector, and a belt support system having a backing layer.

FIG. 10-10a are perspective view of other embodiments of a tool bucket with adjustable sidewall support system; adjustable suspension system illustrating a first, second, and third suspension positions of the tool bucket of the present invention when supported or installed over a structure with the adjustable hanging suspension system captured by the bag-suspending connector, and a belt support system having a backing layer.

FIG. 11 is a perspective view of another embodiments of a tool bucket with an adjustable suspension system having a fourth suspension position; and a belt support system having a backing layer.

### DETAILED DESCRIPTION OF THE PRESENT INVENTION

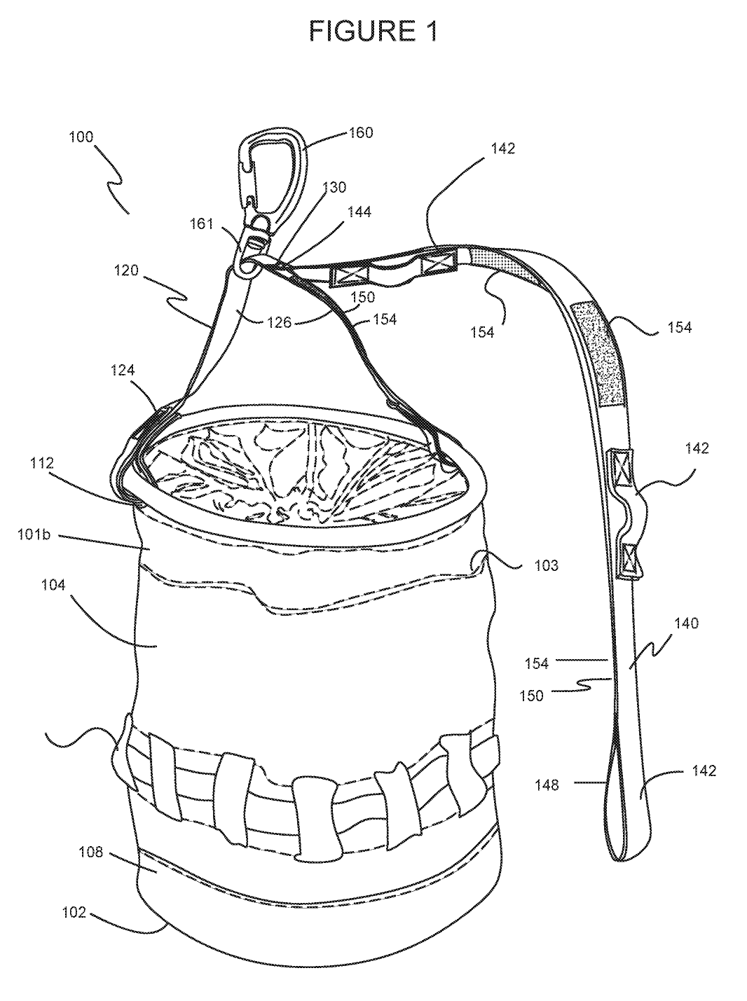

The preferred embodiment(s) of the present invention is illustrated in FIGS. 1-11. FIG. 1 illustrates a front perspective view of one embodiment of a tool bucket 100 that includes a carrying handle 120 with an adjustable hanging suspension system 140 and a bag-suspending connector 160 attached to carrying handle 120. Bag-suspending connector 160 has a connector loop 161, where carrying handle 120 extends through connector loop 161 and allows bag-suspending connector 160 to slide along carrying handle 120. In other embodiments, bag-suspending connector 160 has a fixed position along carrying handle 120.

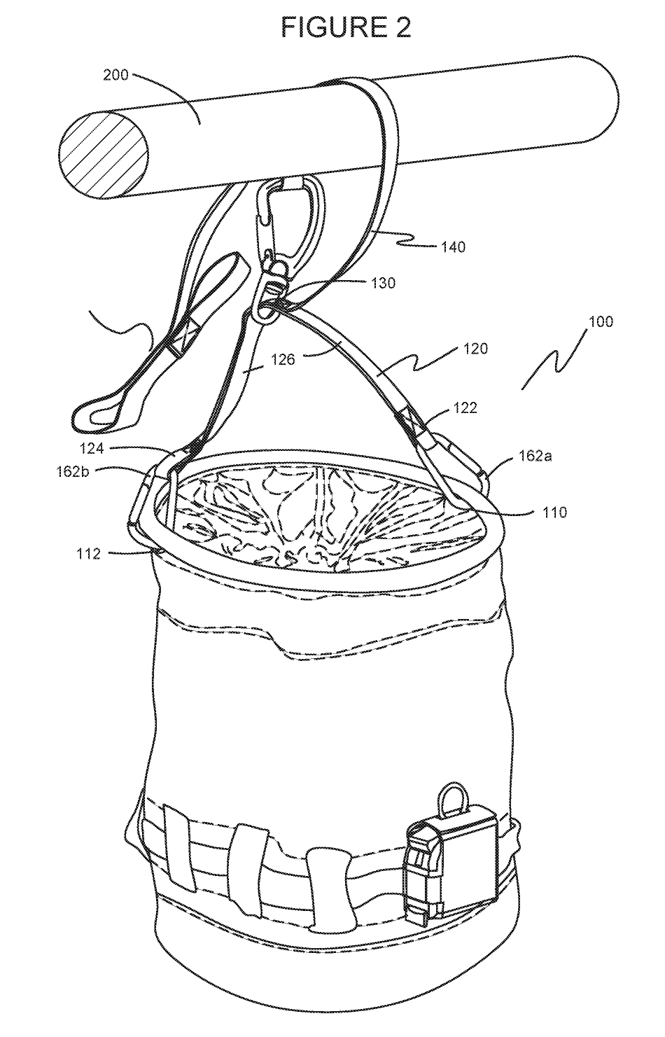

Tool bucket 100 has a container 101 with a bottom 102, a sidewall 104, and an opening or mouth 106, where sidewall 104 extends up from bottom 102 to mouth 106. In FIGS. 1 and 2, an upper sidewall segment 109 and a lower sidewall segment 107 meet adjacent the rigid collar 208. In these figures, the lip(s) 212, 213 are pulled tightly together with a fastener such that the entire upper sidewall segment 109 is folded into and onto itself.

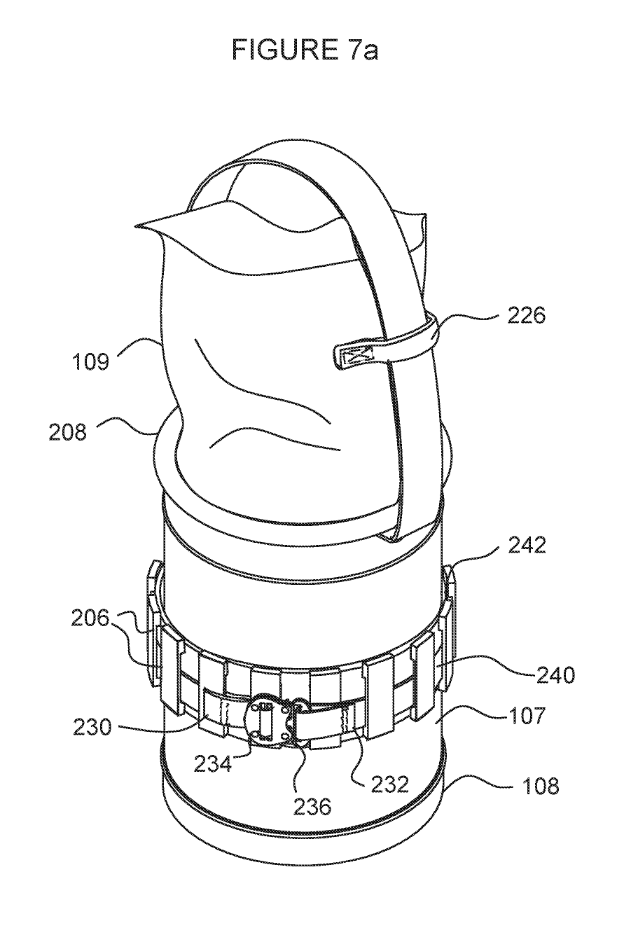

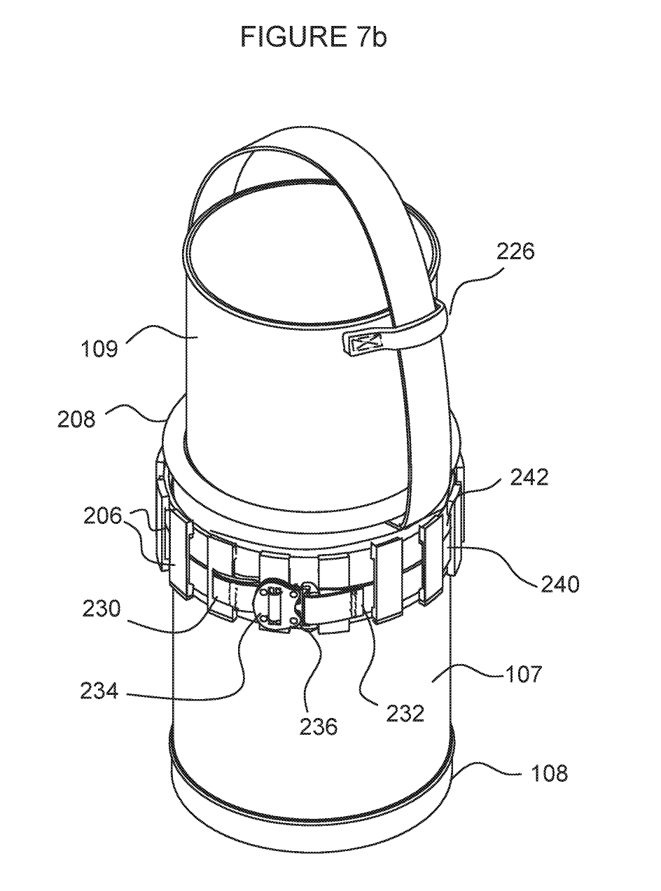

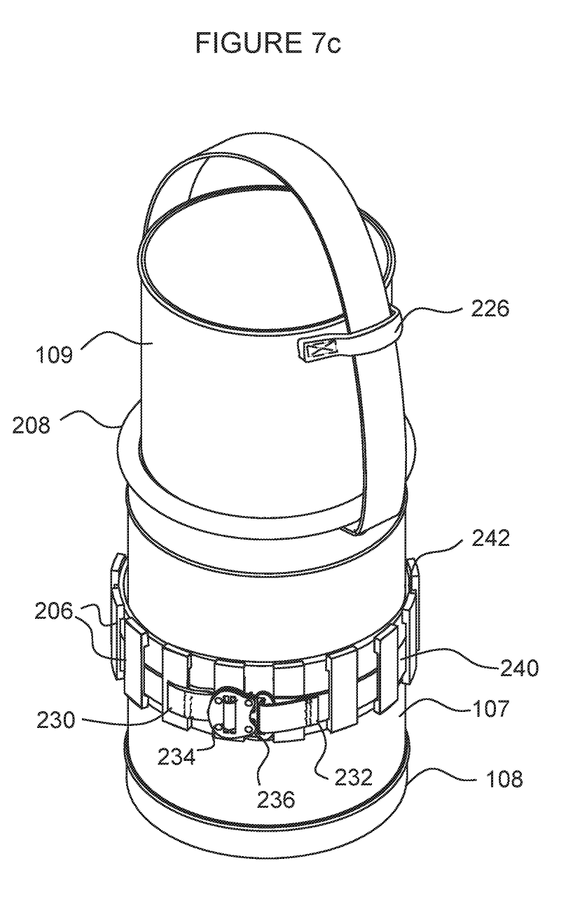

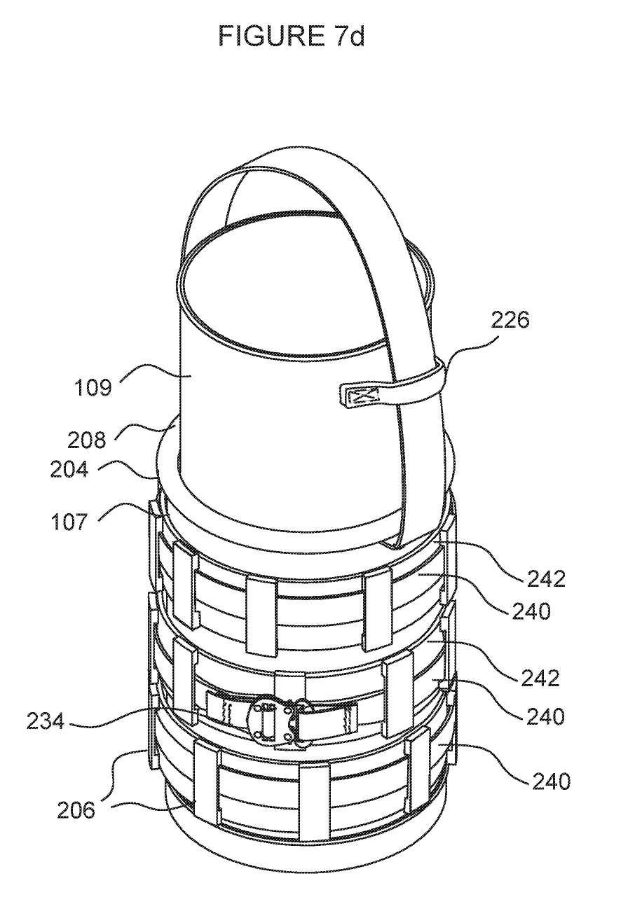

Container 101 is sized and constructed to hold hand tools and hand-held equipment and supplies. In some embodiments, container 101 is made at least in part of a pliable material such as canvas, leather, ballistic nylon, rubberized textiles and the like. In other embodiments, container 101 is made at least in part of rigid materials such as plastic or metal. For example, sidewall 104 is made of ballistic nylon and a sidewall reinforcement segment 108 and bottom 102 are made of hard plastic or rubber. Then, container 101 in another example, is similar to a 5-gallon contractor's container made of plastic (see FIGS. 7-7d). Container 101 may have any shape, but typically has a circular or rectangular shape as viewed looking into mouth 106.

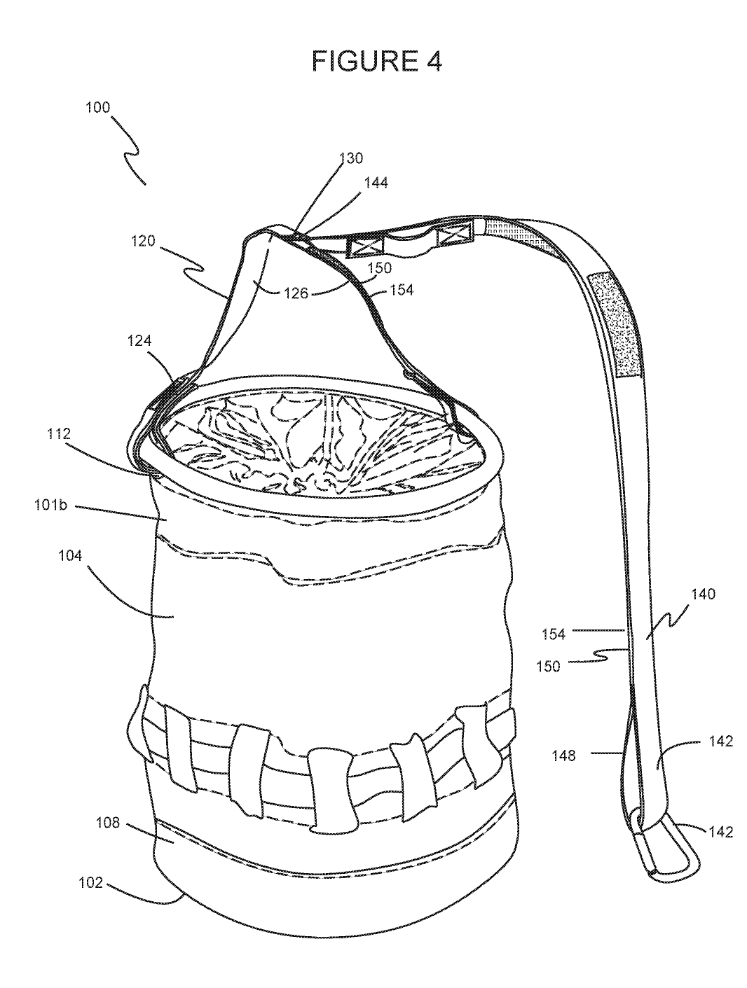

In one embodiment, container 101 defines a first junction 110 and a second junction 112 each located at or near the rigid collar 208 and spaced from each other on opposite sides of collar 208. First and second junctions 110, 112 may be openings defined in lower sidewall segment 104 or in a tab or connector (not shown) connected to and extending from container 101. First and second junctions 110, 112 are useful for connecting carrying handle 120 to container 101, such as when carrying handle 120 extends through first and second junctions 110, 112 and is secured to itself as shown, for example, in FIG. 1 and FIG. 4.

In one embodiment, carrying handle 120 is made of a pliable material and has a handle body portion 126 that extends across the with sufficient slack or length to enable the user to use it to carry tool bucket 100. For example, carrying handle 120 is made of nylon webbing, leather, plastic, or rope. In one embodiment, carrying handle 120 has a first end portion 122 connected to a first side 101a of container 101 and a second end portion 124 connected to a second side 101b of bucket, where first and second end portions 122, 124 are connected adjacent mouth 106 on opposite sides 101a, 101b of mouth 106 of container 101. For example, first and second end portions 122, 124 loop through first and second junctions 110, 112, respectively. In other embodiments, first and second end portions 122, 124 are stitched or otherwise secured to sidewall 104 or to other parts of container 101. In one embodiment, carrying handle 120 extends down along sidewall 104 and across bottom 102 of tool bucket 100 with first and second end portions 122, 124 overlapping and secured to each other and to container 101.

Adjustable hanging suspension system 140 has an auxiliary member body portion 146 with a first auxiliary end portion 144 and a second auxiliary end portion 148. Auxiliary strap body portion 146 extends from first auxiliary end portion 144 to second auxiliary end portion 148, where second auxiliary end portion 148 defines closed loop 142. Adjustable hanging suspension system 140 in some embodiments is a separate length of pliable material that is secured at first auxiliary end portion 144 to handle body portion 126 of carrying handle 120. In one embodiment, closed loop 142 is formed by securing second auxiliary end portion 148 to itself or to auxiliary strap body portion 146. In other embodiments, closed loop 142 is a closed loop of a connector, ring, or other structure secured to second auxiliary end portion 148.

In some embodiments, adjustable hanging suspension system 140 is secured to carrying handle 120 at a midpoint 130 of handle body portion 126 located between first side 101a and second side 101b of container 101. When adjustable hanging suspension system 140 is a separate piece of material from carrying handle 120, for example, adjustable hanging suspension system 140 originates at first auxiliary end portion 144 that is secured at or near midpoint 130 of handle body portion 126 of carrying handle 120. Auxiliary strap body 146 then extends to second auxiliary end portion 148 as a separate structure that can be aligned with carrying handle 120. On the other hand, when adjustable hanging suspension system 140 is formed as an extension of first end portion 122 of carrying handle 120, for example, first end portion 122 is secured to handle body portion 126 at midpoint 130 and then continues as adjustable hanging suspension system 140 separately from carrying handle 120 to second auxiliary end portion 148. In either case, adjustable hanging suspension system 140 may be aligned with and abut carrying handle 120 along at least part of its length. In other embodiments, first auxiliary end portion 144 is movable along carrying handle 120 rather than having a fixed location.

In some embodiments, tool bucket 100 includes a releasable fastener 150 with a first fastener part 152 and a second fastener part 154. For example, adjustable hanging suspension system 140 includes a first fastener part 152 and the corresponding section of carrying handle 120 includes a second fastener part 154 of a releasable fastener 150. In one embodiment, releasable fastener 150 is a hook-and-loop fastener where first fastener part 152 is the hook portion secured along handle body portion 126 of carrying handle 120 and second fastener part is the loop portion 154 secured along auxiliary strap body portion 146. Other acceptable variants of releasable fastener 150 include magnets, snaps, buttons, or other fasteners. When adjustable hanging suspension system 140 extends along and is brought together in alignment with handle body portion 126 of carrying handle 120, first and second fastener parts 152, 154 are aligned for fastening to each other.

Referring now to FIG. 2, a front perspective view illustrates another embodiment of tool bucket 100 with carrying handle 120. First end portion 122 has a first-end connector 162a and second end portion 124 has second-end connector 162b. In some embodiments, one or both of first-end connector 162a and second-end connector 162b defines a closed loop and is operable between an open position and a closed position. First-end and second-end connectors 162a, 162b are constructed for releasable attachment to tool container 101. Therefore, carrying handle 120 is removable from container 101.

In some embodiments as also shown in FIG. 2, for example, part of carrying handle 120 defines adjustable hanging suspension system 140. For example, carrying handle 120 is made of webbing where second end portion 124 is connected through second-end connector 162b and then extends along strap handle body portion 126 of carrying handle 120 to become adjustable hanging suspension system 140. Second end portion 124 extends back along handle body portion 126 with second end portion 124 secured at or near midpoint 130 of handle body portion 126. From midpoint 130, second end portion 124 extends unattached from carrying handle 120 as adjustable hanging suspension system 140 and continues separately from carrying handle 120.

FIG. 2 further shows tool bucket 100 in use with adjustable hanging suspension system 140 looped over a structure 200 (e.g., a pipe) with closed loop 142 captured by bag-suspending connector 160. As shown, for example, bag-suspending connector 160 is hook that engages closed loop 142 to close adjustable hanging suspension system 140 in a loop around structure 200. In other embodiments, bag-suspending connector 160 is a carabiner that clips to closed loop 142. As shown in FIG. 2, carrying handle 120 and auxiliary lop member 140 are a strap made of nylon webbing, leather, or the like.

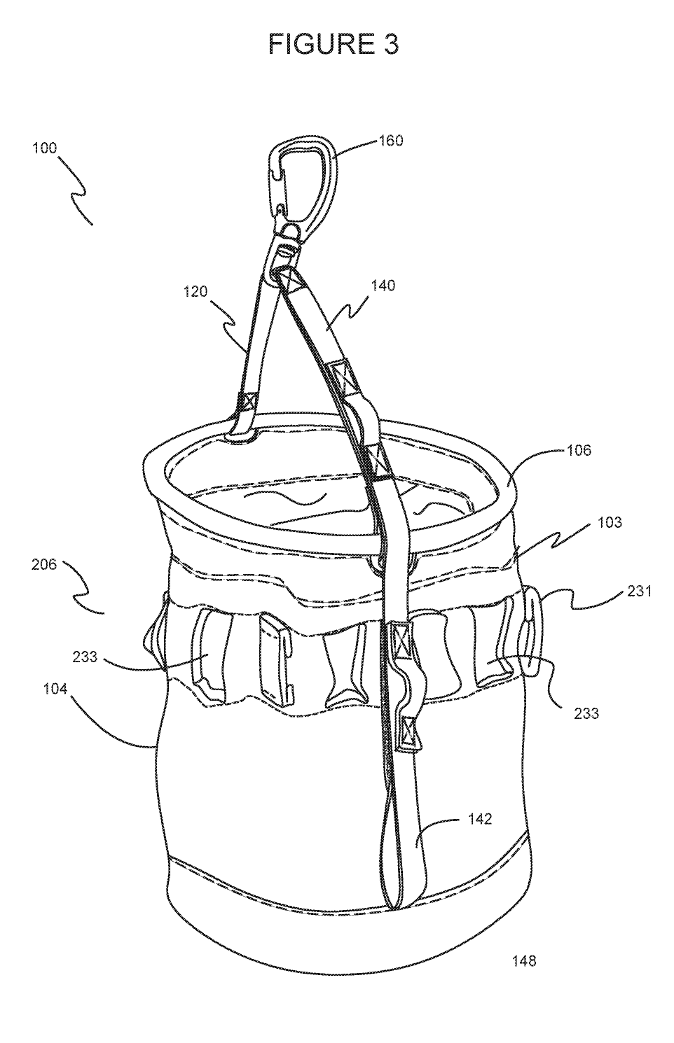

Referring now to FIG. 3, a perspective view illustrates yet another embodiment of tool bucket 100 and the adjustable hanging suspension system 140 with carrying handle 120. In some embodiments, second auxiliary end portion 148 extends beyond mouth 106 of container 101 when auxiliary strap body 146 can be releasably attached along carrying handle 120. To retain adjustable hanging suspension system 140 in a stowed position, carrying handle 120 and container 101 optionally both include second fastener part 154 (e.g., hooks of hook-and-loop fastener) and auxiliary strap body 146 includes first fastener part 152 (e.g., loops of hook-and-loop fastener.)

In the stowed position, auxiliary strap body 146 extends along carrying handle 120 and down along sidewall 104 of container 101 with adjustable hanging suspension system 140 retained by releasable fastener 150. By extending from midpoint 130 to a location along sidewall 104 of container 101, adjustable hanging suspension system 140 has a length better suited to wrap around conduits, beams, and larger structures 200 with sufficient length for closed loop 142 to be captured by bag-suspending connector 160. In other embodiments, adjustable hanging suspension system 140 has a length where second auxiliary end portion 148 terminates at or near mouth 106 of container 101.

The adjustable belt support system of the present invention is shown here having a series of belt loops radially spaced about the lower side wall segment of the container 101. Each loop of the series of belt loops 206 is fixedly connected to the container 101. In this embodiment, the series of belt loops includes alternating reinforced outwardly extending loops and internally extending loops formed by reinforced slits in the lower sidewall segment. Each of the axially outward extending loops and the axially inward extending slits ensure that the belt loops are permanently connected to the sidewall. The adjustable belt support system 228 increases an overall carrying capacity and holding volume of the average tool bucket in this manner by around 40%.

FIG. 4 is a perspective view of one embodiment of a flexible tool bucket with a suspension system having an adjustable hanging suspension system. The belt support system and carrying handle of the present invention with connector along the final auxiliary loop. A sidewall reinforcement segment 108 is provided directly abutting the bottom 102, ensuring that the tool bucket can withstand a 200 lb drop force.

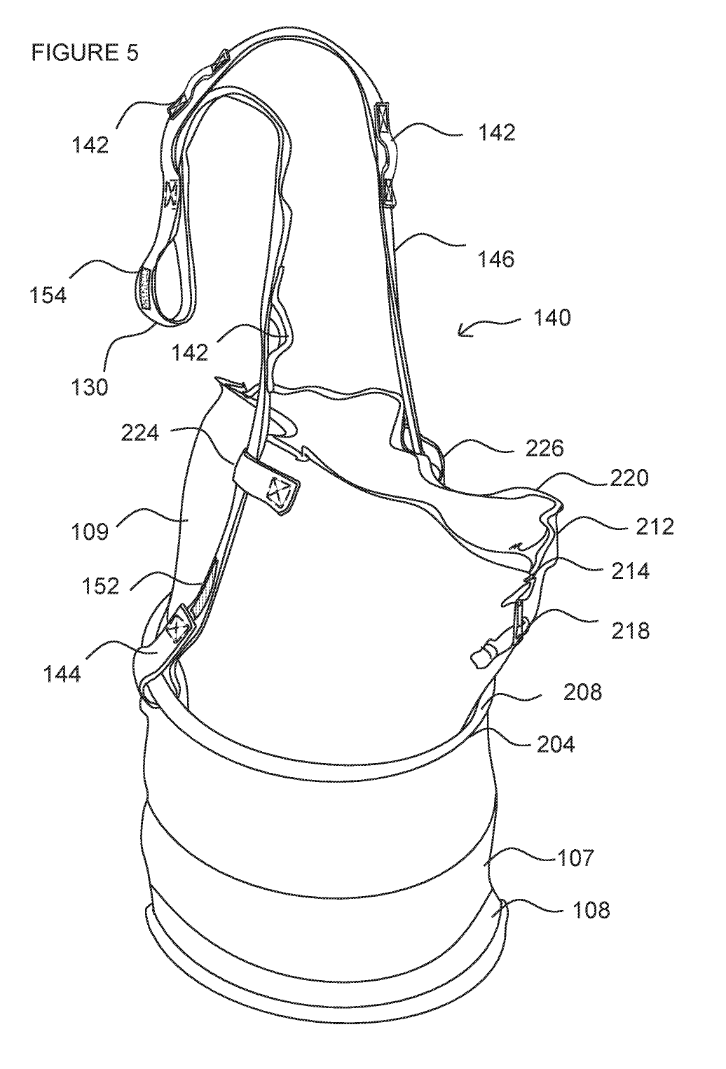

Shown in FIG. 5 is one embodiment according to the present invention, having a flexible tool bucket with an adjustable side wall support system, an adjustable hanging suspension system, and an openable mouth. The support system has a carrying handle 120 made of a pliable material and has a longer handle body portion 126 that extends with sufficient slack or length to enable the user to use it to carry tool bucket 100. For example, carrying handle 120 is made of nylon webbing, leather, plastic, or rope. The carrying handle 120 has a first end portion 122 connected to a first side 101a of container 101 and a second end portion 124 connected to a second side 101b of bucket. Note that first and second end portions 122, 124 are connected adjacent and surrounding respective portions of the rigid collar 208 on opposite sides 101a, 101b of container 101.

First and second end portions 122, 124 are able to loop through first and second junctions 110, 112 respectively because of the sidewall channel 105 which extends circumferentially about the inner sleeve/upper sidewall segment 109. The axially outward facing channel sidewall segment 105b dips downward past the rigid collar 208 until meeting the channel floor 103 and then the axially inward facing channel sidewall segment 105a reaching upward.

At this point, the axially inward facing channel sidewall segment 105a reaches the sidewall pocket segment 204 encompassing the rigid collar 208 which forms an integral part of the adjustable sidewall support system. In this embodiment, the sidewall pocket segment 204 is affixed along the sidewall naturally by being formed integrally by a folding portion of the lower sidewall segment.

In this embodiment, the sidewall pocket 204 permanently and continually holds the girdle member/rigid collar 208, a welded rigid ½ in.×48 in. curved plain steel round rod. However, in other embodiments, multiple open loops 206 radially situated about the sidewall hold a removable girdle member.

This embodiment also has a sliding fastener 218 capable of reversibly interlocking two toothed opposing tracks 220, positioned along the first and second lips 212 of the open mouth. While being able to close the otherwise open mouth of the bucket is essential in preventing spills, the sliding fastener 218 adds additional weight to the already flexible upper sidewall segment 109. This additional weight causes the flexible wall to collapse in upon itself, making retrieving tools unwieldy and time consuming.

To address this, two other elements of the adjustable sidewall support system, the first sidewall support bracket 224, and second sidewall support bracket 226, are also provided. The first sidewall support bracket 224, and second sidewall support bracket 226, work in concert with one another to hold open the closable mouth of the flexible inner sleeve 109. By passing the auxiliary strap 146 or handle of the adjustable hanging suspension through these brackets 224, 226, the weight of the tools placed within the container act as a counterbalance to the weight of the fastener 218. The weight of the tools themselves within the bucket then causes the lips of the upper sidewall segment along the mouth to open in order to reduce the tension along the sides of the auxiliary strap 146.

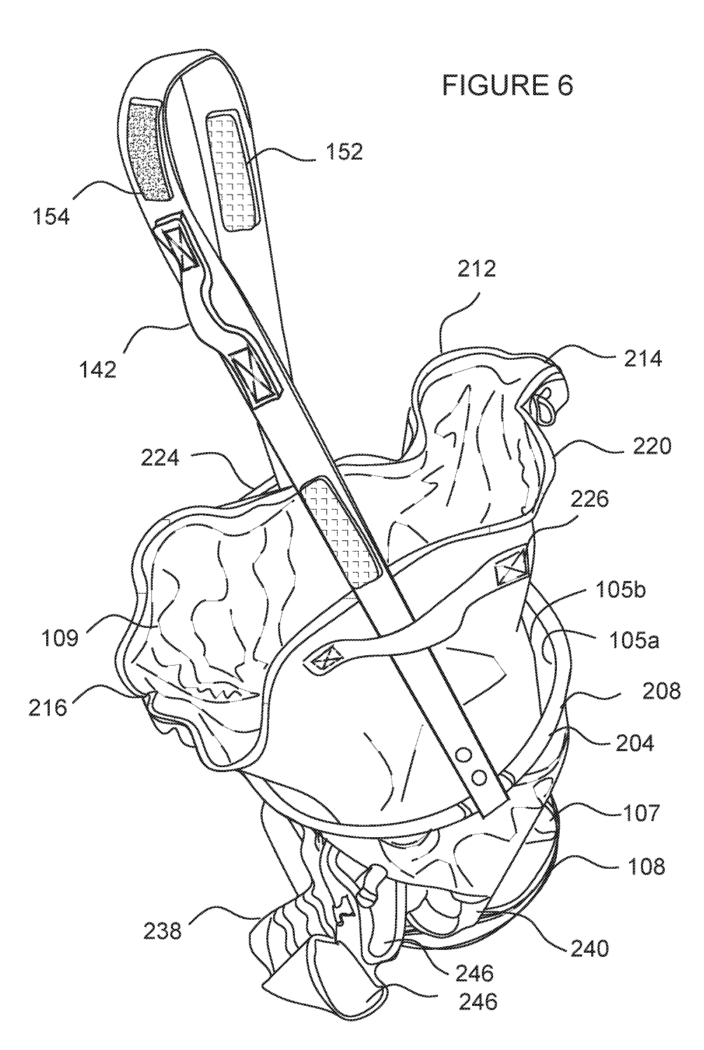

In FIG. 6 is a perspective view of one embodiment of a flexible tool bucket with an adjustable side wall support system; an adjustable hanging suspension system; and an adjustable belt support system. The adjustable belt support system of the present invention is shown here supporting a drill holster 238. The drill holster is supported along a belt 240 which is in turn supported by a series of belt loops radially spaced about the lower side wall segment of the container 101. Each loop of the series of belt loops 206 is fixedly connected to the container 101. In some embodiments this permanent connection is either direct or via a backing 242 which is permanently connected to the sidewall.

Construction workers are accustomed to using tool belt harnesses for carrying a wide variety of tools. However, it is not always convenient to maneuver with several tool belt harnesses attached to one's belt, reducing the range of motion. These tools must then necessarily be carried elsewhere and elsewise. However, taking the time to remove the harnesses from the tools and then replacing the harnesses to the tools when useful is a very tedious and time-consuming process. Most workers unwilling to remove the harnesses for these reasons, simply leave the harnesses on their tools and carry tools and harnesses in larger tool bags. However, these tools and tool harnesses quickly begin to take up all of the available space within the tool bag.

The present tool bucket addresses these foregoing issues by providing the adjustable belt support system 228 which increases an overall carrying capacity and holding volume of the average tool bucket by around 50%. At this level, the limit becomes how much weight one can carry, and not how much the bag can hold in the internal cavity 106a.

Another feature shown in this embodiment are the reversible clips employed to reversibly connect the first and second end portions 122, 124 of the auxiliary member strap 146. End portion 122 is shown going through the adjustable sidewall support system first sidewall support bracket 224, going around the rigid collar 208, going through the first junction 110, and folding back upon itself to snap closed. Strap portion 124 is not shown via this perspective however it also joins and works with the second side wall support bracket 226 and the second junction 112 in order to support the upper side wall segment along the opposed side.

FIGS. 7-7e are perspective views embodiments according to the present invention having a rigid tool bucket with an adjustable inner sleeve. Similar to previous embodiments, container 101 is sized and constructed to hold hand tools and hand-held equipment and supplies. Unlike previous embodiments, the container 101 is made at least in part of rigid materials such as plastic or metal. The container 101 shown here is similar to a 5-gallon contractor's container made of plastic. In FIG. 7a, the upper sidewall segment 109 is made of ballistic nylon while the lower sidewall segment 107, sidewall reinforcement segment 108, and bottom 102 are made of hard plastic or rubber. Together, the bucket can withstand a drop force of over 200 lbs.

The adjustable belt support system is made at least in part of a pliable material such as canvas, leather, ballistic nylon, rubberized textiles and the like. The adjustable belt support system has a locking belt 240 supported by the adjustable belt support system. The belt 240 has a first belt terminus with a first locking component 234 capable of releasably interlocking with a second locking component 236 located at a second belt terminus 232.

The adjustable sidewall support system in this embodiment employs a more rigid auxiliary strap 146 together with the first sidewall support bracket 224 and second sidewall support bracket 226. The first sidewall support bracket 224, and second sidewall support bracket 226, work in concert with one another to hold open the closable mouth of the flexible inner sleeve 109. By passing the auxiliary strap 146 or handle of the adjustable hanging suspension through these brackets 224, 226, the container acts as a counterbalance to the weight of the flexible inner sleeve 109. The weight of the tools themselves is not necessary within the bucket as the weight of the container 101 causes the lips of the upper sidewall segment along the mouth to remain open in order to reduce the tension along the sides of the auxiliary strap 146.

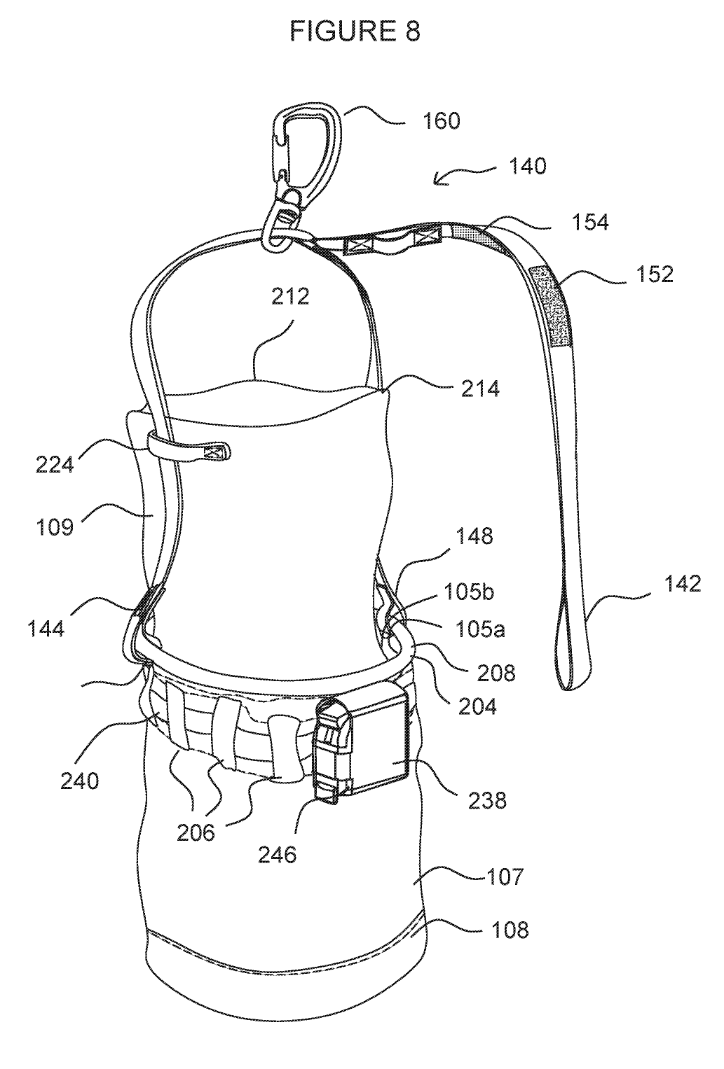

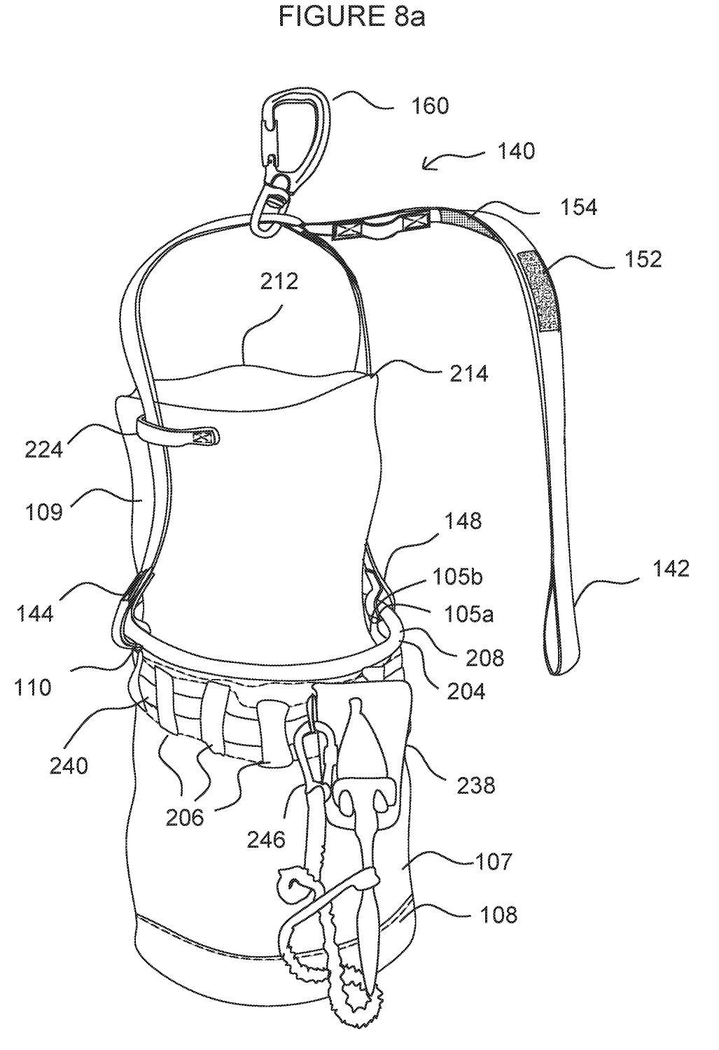

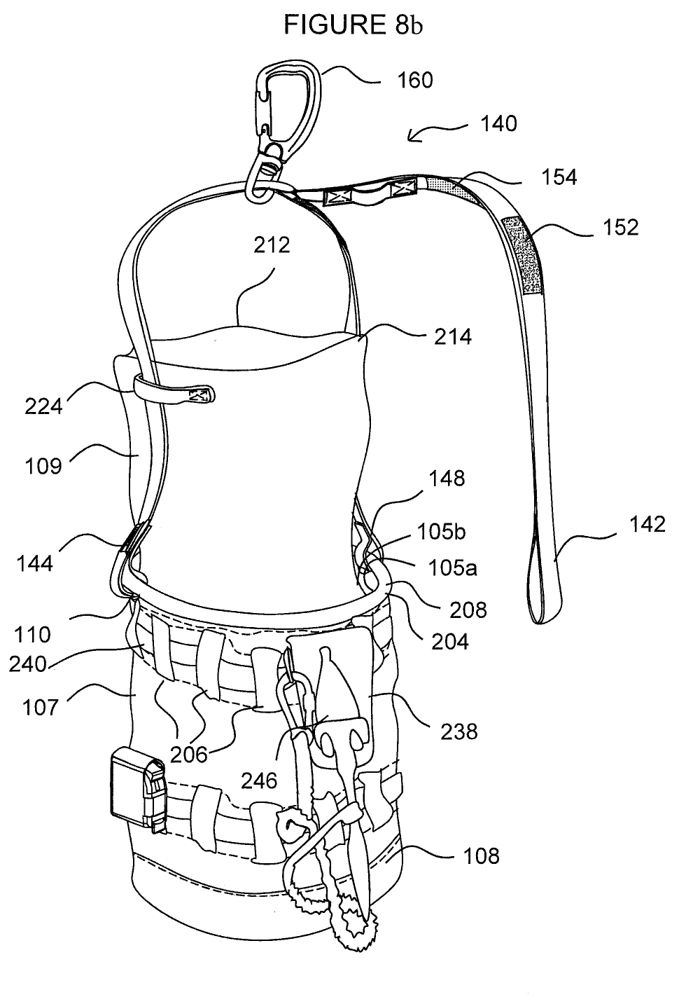

FIG. 8-8b shows perspective views of a flexible tool bucket with a suspension system, sidewall support system, carrying bracket, belt support system, and carrying handle of the present invention. These illustrate that the adjustable tool belt support system 228 is capable of having more than a single series of belt loops 206, and for each, belt 240, respective first belt terminus 230, second belt terminus 232, first belt locking component 234, and second belt locking component 236.

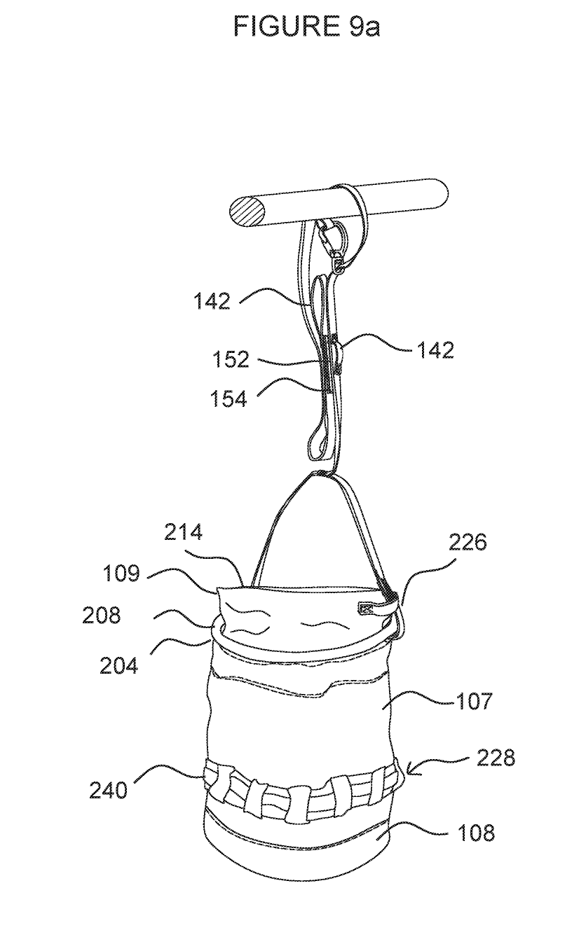

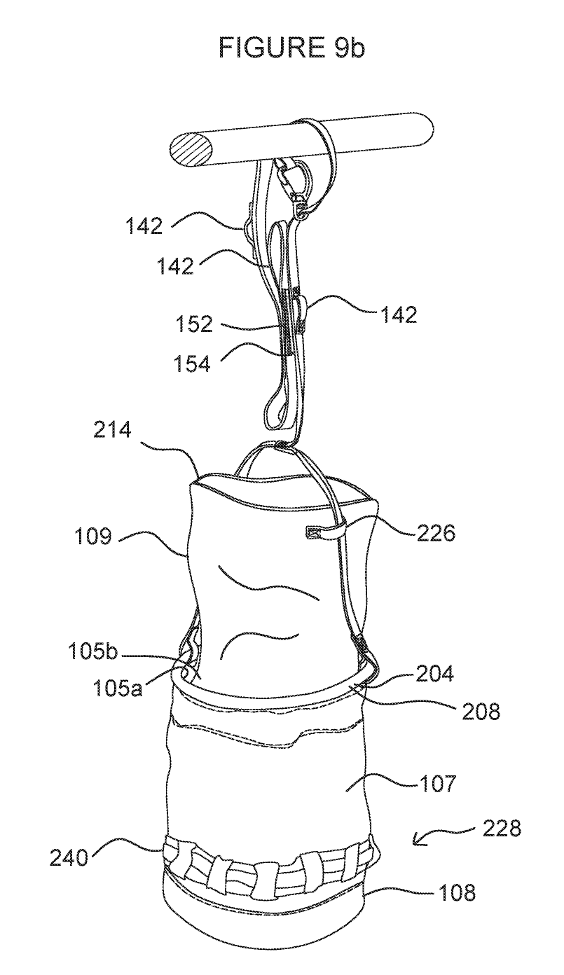

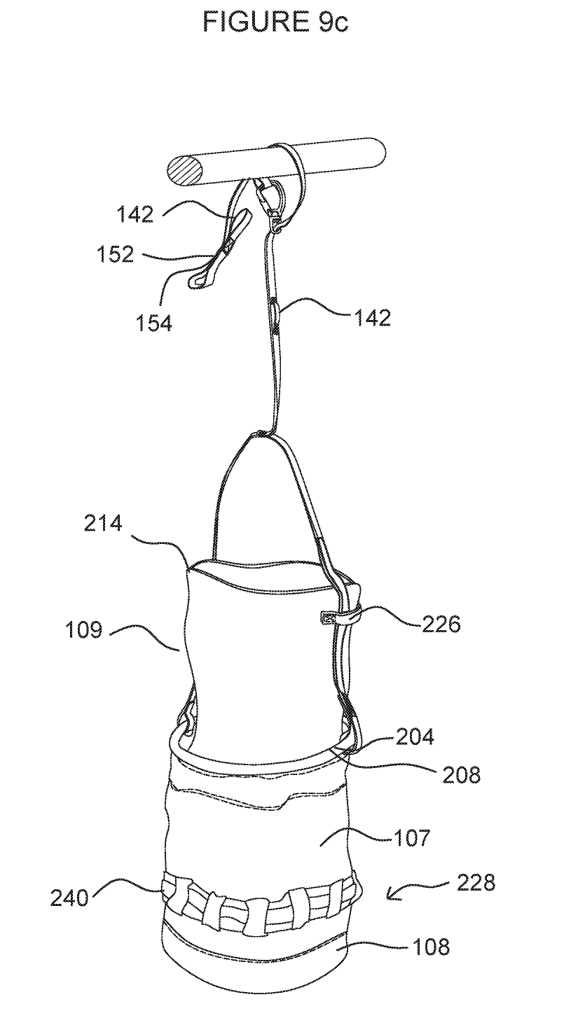

FIG. 9-9c are perspective view of another embodiment of a tool bucket with adjustable sidewall support systems, and a belt support system having a backing layer. In FIG. 9, the adjustable suspension system illustrates a first suspension position of the tool bucket of the present invention when supported or installed over a structure with the adjustable hanging suspension system captured by the bag-suspending connector. In FIG. 9c, the adjustable suspension system illustrates a second suspension position of the tool bucket of the present invention when supported or installed over a structure with the adjustable hanging suspension system captured by the bag-suspending connector. In FIG. 9c, the adjustable suspension system illustrates a third suspension position of the tool bucket of the present invention when supported or installed over a structure with the adjustable hanging suspension system captured by the bag-suspending connector.

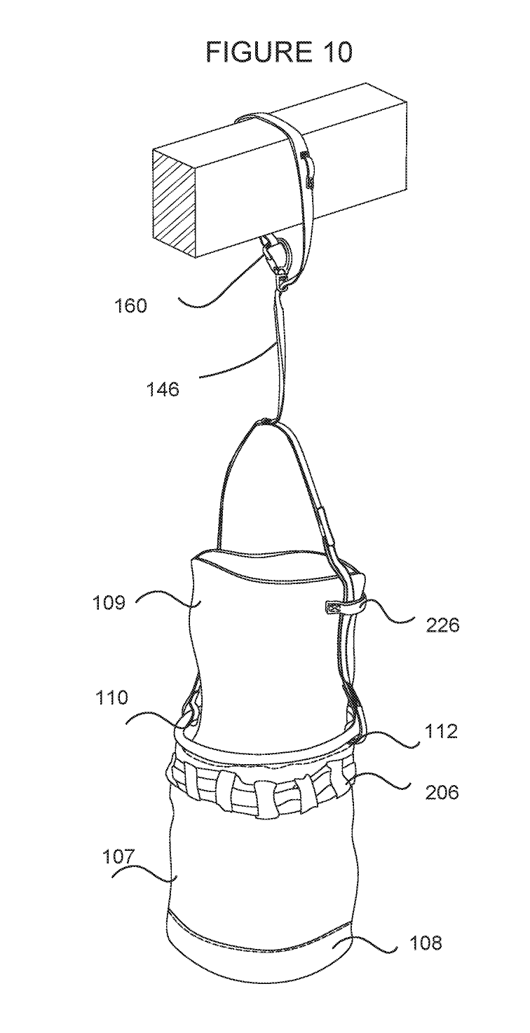

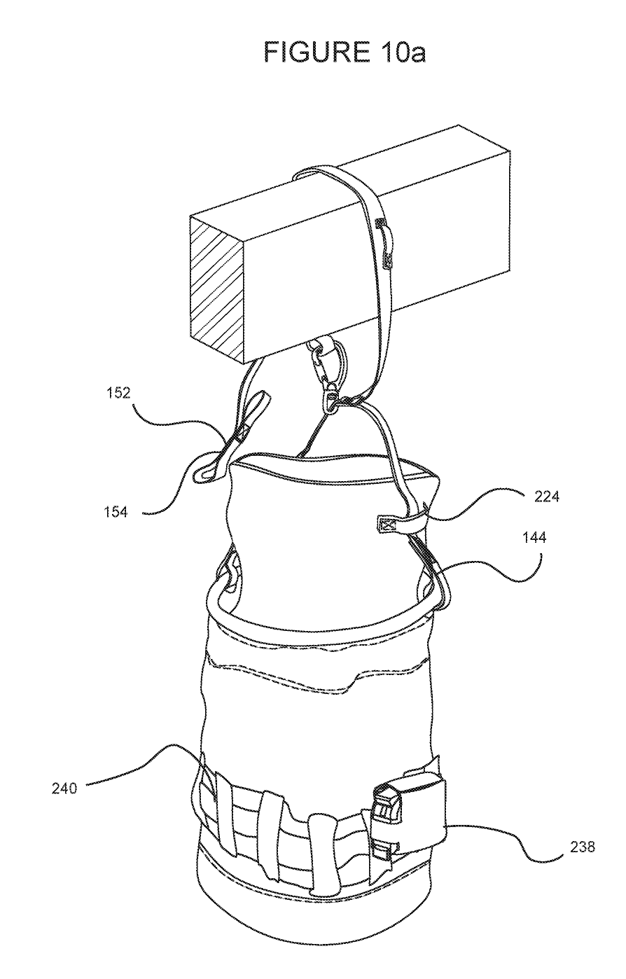

FIGS. 10-10a are perspective views of another embodiment of a tool bucket with adjustable sidewall support system. Each of the belt support system shown here have a backing layer. In FIG. 10, the adjustable suspension system illustrates a fourth suspension position of the tool bucket of the present invention when supported or installed over a structure with the adjustable hanging suspension system captured by the bag-suspending connector. In FIG. 10a, the adjustable suspension system illustrates a fifth suspension position of the tool bucket of the present invention when supported or installed over a structure with the adjustable hanging suspension system captured by the bag-suspending connector.

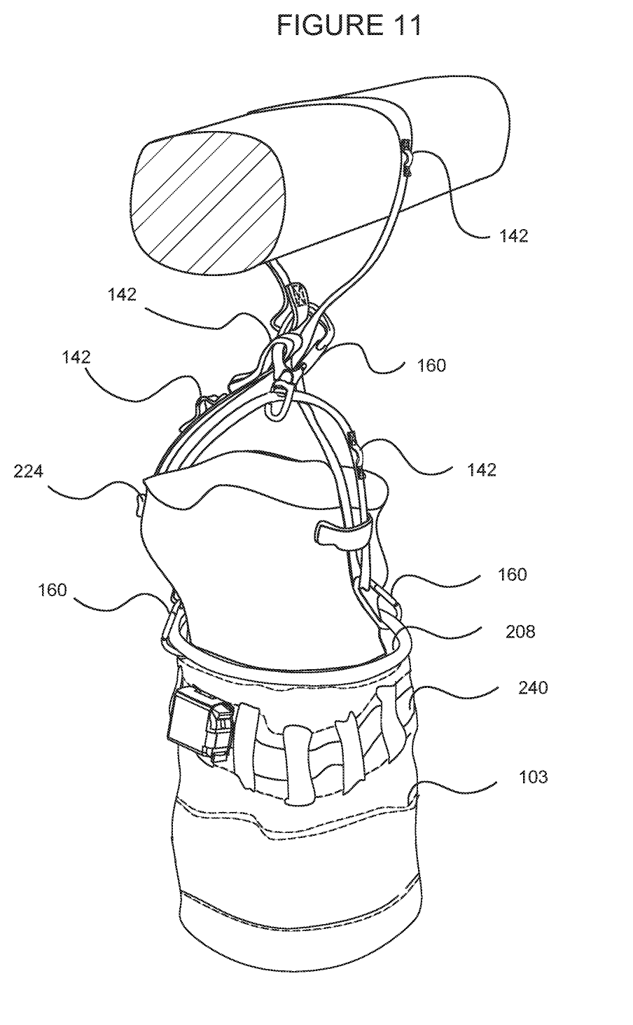

FIG. 11 is a perspective view of another embodiment of a tool bucket with an adjustable suspension system having a fourth suspension position. In this figure, the tool bucket 100 has a container 101 where the internal cavity 106a has a volume dependent upon the size of the bottom 102 and the sidewall 104. This volume is adjustable, making the tool bucket expandable as the sidewall 104 has a first sidewall contracted position 200 and a second sidewall expanded position 202. A first side 101a of the tool bucket 100 has a first side 101a having a first junction 110. Opposite the first side 101a, a second side 101d has a second junction 112. Each of the first and second junctions 110, 112 are capable of joining with either first and second end portions 122, 124 of the adjustable hanging suspension systems.

An opening or mouth 106 extends along an uppermost portion of the sidewall upper segment 109. In this embodiment, the mouth is openable or closeable, as desired, as a sliding fastener 218 capable of interlocking first and second toothed tracks 220 extends along first and second lips 212 between first and second corners 214, 216.

The adjustable hanging suspensions system 140 of this embodiment has a single auxiliary member strap 146 having a first auxiliary end portion 144 and a second auxiliary end portion 148. Although not shown in this figure, the carrying handle 120 is formed from a portion of the auxiliary member strap 146, securely connected to the desired closed loop 142. In that instance, the first end portion 122 and the second end portion 124 would be formed similarly from the corresponding closed loops 142. It is anticipated that a colored coding system may be used to identify the different combinations of loops in order to quickly move from the various extension possibilities. That is, for a first sized handle 120, red would identify the closed loop 142 for the first portion 122, the closed loop 142′ for the second end portion 124, the closed loop 142″ the connector loop, etc.

The connector loops 161, 160 work in concert with the multiple corresponding closed loops 142 to provide each of a first, second, third, and fourth suspension position of the tool bucket. The releasable fastener 150, usually comprising a first fastener part 152 or hooked surface and a second fastener part 154 having a looped surface, ensure that any extraneous sections of auxiliary member strap 146 remain organized and out of the way of forming any encumbrances.

As with previous embodiments, the sidewall upper segment 109 extends from the sidewall channel floor 103—the portion of the sidewall upper segment 109 secured to the sidewall lower segment 107. In this embodiment, the channel has a greater height, and the sidewall upper segment 109 has a height which is greater than the sidewall lower segment 107. The axially inward facing channel wall 105a is perforce, the same height as the axially outward facing channel wall 105b. This combination is preferred when it is desirable to have a smaller internal lower pocket which remains closed while a larger opened pocket formed above the now-closed mouth is now capable of acting to contain tools on top of the closed pocket.

The adjustable sidewall support system 222 in this embodiment has first and second sidewall support brackets 224, 226 which together with the rigid girdle member/rigid collar 208 facilitate maintaining an ‘opened’ mouth when desired. The releasable connector 160 ensures that a portion of the supporting member strap 146 may be removed from the brackets 224, 226 when having the dual pocket formation described above. The reinforcement sidewall segment 108 along the perimeter 210 of the sidewall also serves to provide further support and rigidity in each of these formations.

The adjustable tool belt support system 228 shown here has a series of belt loops 206 extending radially about the lower sidewall 107. Although not visible in this figure (see FIG. 7a), the belt 240 has a first belt terminus 230 and second belt terminus 232 have interlocking first belt locking component 234 and second belt locking component 236. This ensures that the belt is capable of receiving multiple and varied tool holsters 238.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

We claim:

1. A tool bucket comprising:
a container having a bottom, a sidewall having a sidewall lower portion and a sidewall upper segment, the sidewall extending up from the bottom to a mouth, and a rigid collar extending along a perimeter of the sidewall parallel to yet spaced apart from both the bottom and the mouth, the sidewall being capable of expanding from a first position to at least a second position relative to the bottom,
a carrying handle having a body portion, a first junction, and a second junction, wherein the first junction securely attaches the carrying handle to the container adjacent the rigid collar and the second junction securely attaches the carrying handle to the container adjacent the rigid collar and spaced from the first junction, the body portion being capable of extending over the mouth of the container; and
an adjustable component system including at least one of:
an adjustable hanging suspension system having a bag-suspending connector and an adjustable hanging suspension system, the bag-suspending connector being connected to the carrying handle, the adjustable hanging suspension system having an auxiliary member body portion extending between a first auxiliary end portion to a second auxiliary end portion, the auxiliary member body portion capable of being aligned with the carrying handle, the second auxiliary end portion defining a closed loop; and the first auxiliary end portion secured to the handle body portion;
an adjustable sidewall support system having a first sidewall support connected to the sidewall upper segment adjacent yet spaced from the mouth, a second sidewall support connected to the sidewall upper segment adjacent yet spaced from the mouth and opposite the first sidewall support, the first sidewall support capable of slidingly engaging the carrying handle thereby sliding between a first position adjacent the first junction and a second position spaced apart from the first junction, the second sidewall support capable of slidingly engaging the carrying handle thereby sliding between a first position adjacent the second junction and a second position spaced apart from the second junction; and
an adjustable tool belt support system having a series of belt loops radially spaced around the sidewall of the container, and each of the series of belt loops being fixedly connected to the container.

2. The tool bag of claim 1, wherein the at least one adjustable component system is the adjustable sidewall support system wherein:
a total internal channel volume of the tool bucket increases when the sidewall expands from the first position to the second position relative to the bottom;
a first sidewall support is connected to the sidewall upper segment adjacent yet spaced from the mouth;
a second sidewall support is connected to the sidewall upper segment adjacent yet spaced from the mouth and opposite the first sidewall support,
the first sidewall support is capable of slidingly engaging a first side of the carrying handle thereby sliding between a first position adjacent the first junction and a second position spaced apart from the first junction; and
the second sidewall support is capable of slidingly engaging a second side of the carrying handle thereby sliding between a first side position adjacent the second junction and a second side position spaced apart from the second junction.

3. The tool bag of claim 1, wherein the at least one adjustable component system is the adjustable tool belt support system; the series of belt loops are equally radially spaced about the sidewall of the container; each of the series of belt loops being fixedly connected to the container; a belt extends through the series of belt loops and has a first belt terminus with a first locking component and an opposing second belt terminus with a second locking component, the first belt terminus releasably interlocking with the second locking component.

4. The tool bag of claim 1, wherein the adjustable component system is the adjustable hanging suspension system and the first auxiliary end portion of the auxiliary loop member is secured at about a midpoint of the carrying handle and the auxiliary member body portion has a length sufficient to extend along the sidewall when the auxiliary loop member is releasably attached to the handle body portion.

5. The tool bag of claim 1, wherein the adjustable component system is the adjustable hanging suspension system having a flexible main section extending from a first connector to a second connector, the first connector being secured to the body portion of the carrying handle, and the flexible main section capable of at least a first configuration being aligned with the carrying handle and a second configuration progressing away from the carrying handle.

6. The tool bag of claim 1, wherein the adjustable component system is the adjustable tool belt support system comprising a belt extending through the series of belt loops and the belt having a first belt terminus having a first locking component releasably interlocking with a second locking component located at a second belt terminus.

7. The tool bag of claim 1, wherein the adjustable component system is the adjustable hanging suspension system capable of releasably moving between a first configuration and a second configuration, wherein the adjustable hanging suspension system alters a handle hanging length when moved between the first configuration and the second configuration;
in the first configuration, the adjustable hanging suspension system enables the carrying handle to evenly support the tool bucket from a hanger with a circumference of up to 2.54 cm;
in the second configuration adjustable hanging suspension system enables the carrying handle to evenly support the tool bucket from a hanger with a circumference of more than 25.4 cm;
in a third configuration adjustable hanging suspension system enables the carrying handle to evenly support the tool bucket from a hanger with a circumference of more than 50.8 cm;
in a fourth configuration adjustable hanging suspension system enables the carrying handle to evenly support the tool bucket from a hanger with a circumference of more than 76 cm;
in a fifth configuration adjustable hanging suspension system enables the carrying handle to evenly support the tool bucket from a hanger with a circumference of less than 127 cm.

8. The tool bag of claim 1, wherein the adjustable component system is the adjustable tool belt support system and the series of belt loops includes one of reinforced internally extending loops and outwardly extending loops.

9. A tool bucket comprising:
a container having a bottom, a sidewall extending up from the bottom to a mouth, and a rigid collar extending along a perimeter of the sidewall parallel to yet spaced apart from both the bottom and the mouth;
a carrying handle having a body portion, a first junction, and a second junction, wherein the first junction securely attaches the carrying handle to the container adjacent the rigid collar and the second junction securely attaches the carrying handle to the container adjacent the rigid collar and spaced from the first junction, the body portion being capable of extending over the mouth of the container;
an adjustable hanging suspension system having a bag-suspending connector and an adjustable hanging suspension system, the bag-suspending connector being connected to the carrying handle, the adjustable hanging suspension system having an auxiliary member body portion extending between a first auxiliary end portion to a second auxiliary end portion, the auxiliary member body portion capable of being aligned with the carrying handle, the second auxiliary end portion defining a closed loop; and the first auxiliary end portion secured to the handle body portion; and
at least one adjustable component system capable of increasing a holding capacity of the tool bucket.

10. A tool bucket comprising:
a container having a bottom, a sidewall extending up from the bottom to a mouth, and a rigid collar extending along a perimeter of the sidewall parallel to yet spaced apart from both the bottom and the mouth;
a carrying handle having a body portion, a first junction, and a second junction, wherein the first junction and the second junction securely attach the carrying handle to the container opposite one another such that the body portion extends away from the mouth of the container;
at least one adjustable component system capable of facilitating altering a suspension height of the tool bucket; and
an adjustable tool belt support system having a series of belt loops radially spaced around the sidewall of the container, each of the series of belt loops being fixedly connected to the container, a belt extending through the series of belt loops and having a first belt terminus having a first locking component releasably interlocking with a second locking component located at a second belt terminus.
